(19) United States
(12) Patent Application Publication
(10) Pub. No.: US 2008/0179558 A1
(43) Pub. Date: Jul. 31, 2008

(54) Self-adjusting seat for rotary valve

(75) Inventor: Sam Sun Lloyd, Houston, TX (US)

Correspondence Address: BURLESON COOKE L.L.P., 2040 NORTH LOOP 336 WEST, SUITE 123, CONROE, TX, 77304, US

(73) Assignee: Hemiwedge Valve Corporation

(21) Appl. No.: 11/699,518

(22) Filed: Jan. 29, 2007

(51) Int. Cl. F16K 25/00

(52) U.S. Cl. 251/180

(57) ABSTRACT

A valve seat assembly is provided for rotatable valves. The assembly has concentric rings with a spring to apply force to cause the inner ring to slide within the outer ring. There is a sliding pressure seal between the sliding surfaces. The main seal, adapted to seal against a rotating seal element, is disposed on the outer ring. A second seal, adapted to seal against the wall of the cavity in a valve body, is disposed on the inner ring. A spring may be placed in a groove in the inner or outer ring and selected to provide a force to push apart the main seal and the second seal. The diameter of the sliding seal between the rings is greater than the diameter of the second seal and the diameter of the main seal.

### BACKGROUND OF INVENTION

1. Field of the Invention

This invention relates generally to valves having a rotatable valve element such as a wedge or a ball. More particularly, a valve seat assembly is provided, the assembly including provisions for spring-loading and pressure-actuating seals between the rotatable valve element and the valve body when flow in either direction is controlled.

2. Description of Related Art

Rotatable valves such as ball valves have long been well known in the art. Such valves have in common a valve element positioned to rotate in a valve body and a shaft extending from the valve element through a bonnet. Various modifications of ball valves continue, such as described in U.S. Pat. No. 6,378,842, which discloses a ball valve shaft that is rotatably positionably through the bonnet such that the bonnet, the valve shaft and the valve element can be removed from the valve body without removing the valve body from the piping system where it has been installed.

U.S. Pat. No. 4,137,936 discloses a valve including an emergency sealing device comprising of piston at an end of a fluid inlet passage and a main seat ring. A spring is disposed between the piston and a seat holder. The seat ring may be urged against a valve element by the spring or a pressure medium.

U.S. Pat. No. 4,747,578 discloses a ball valve having a seal that may be spring-loaded against the valve element and a conduit leading to a posterior space behind the seal, the posterior space having a pressure that may force the sealing element away from the seal during rotation and decrease wear on the valve seat.

U.S. Pat. Nos. 4,962,911; 5,333,834 and 5,507,469 disclose a different type of rotatable valve, one that depends on a wedge-shaped sealing element such that a sealing force is applied on the valve seat at selected valve positions. The requirements for close mechanical tolerances in such valves, in effect limiting the “extrusion gap,” can increase the cost of manufacturing such valves. Spacers are usually used in an attempt to achieve proper force on seals to prevent leakage while not unduly increasing the force required to operate the valve. There is also a need to provide sealing of such valves when the valve is used to shut-off flow, both at low- and high-differential pressure, in the direction other than the preferred direction (i.e., the “non-preferred” direction or the “reverse” direction).

U.S. Pub. No. US2006/0196544 discloses a high pressure “cartridge” valve having a wedge-shaped sealing element. The cartridge facilitates repair of the valve by permitting quick removal and replacement without requiring that the housing or body of the valve be removed from the line. There is a need to provide such valves with the ability to seal with high pressure on either side of the valve and to avoid requirements for small mechanical tolerances. If a gap forms between seals when the valve is in the open position, this “extrusion gap” may interfere with the sealing capability or service life of the valve because seals, such as o-rings or molded seals, may be extruded into the gap. When the valve member is rotated under this condition, an extruded section of the seal can become cut or otherwise damaged by the moving valve components.

In general, what is needed is improved apparatus for preventing leakage past the sealing elements of rotary valves when flow is in either direction, while avoiding the requirement for very small tolerance in machining and the attendant high costs of the valves.

### BRIEF SUMMARY OF THE INVENTION

A valve seat having two movable parts is provided for valves, especially rotary valves. The seat provides for sealing with flow in the normal or preferred direction and in the non-preferred or reverse direction, at either low or high differential pressure across the valve. To seal flow in the non-preferred direction, a spring mechanism is provided for low differential pressure sealing and a piston effect between seals on surfaces in the two-piece valve seat is provided for high differential pressure sealing.

### BRIEF DESCRIPTION OF THE DRAWINGS

FIG. 1 (Prior Art) illustrates a rotary cartridge valve.

FIG. 2 is an elevation view of a valve body suitable for the valve seat described herein.

FIG. 3 is a plan view of a wedge-shaped valve element and cartridge valve with one embodiment of a self-adjusting valve seat.

FIG. 4 is a detail of a part of the plan view of the self-adjusting valve seat of FIG. 3.

FIG. 5 is an end view of one embodiment of the self-adjusting valve seat of FIG. 3.

FIG. 6 is a cross-sectional elevation view of one embodiment of the self-adjusting valve seat of FIG. 3.

FIG. 7 is an exploded isometric illustration showing the various components of one embodiment of the self-adjusting valve seat.

FIGS. 8A and 8B are detailed section views of the self-adjusting valve seat showing development of a gap at the seals avoided by spring action.

FIG. 9 is a plan sectional view of the self-adjusting valve seat assembly showing arrows representing fluid pressure on the valve sealing element when the valve is used to control flow in the reverse direction.

FIG. 10 is a plan sectional view of the self-adjusting valve seat assembly illustrating diameters of piston areas used for seal activation when flow is controlled in the reverse direction.

FIG. 11 illustrates the force on the inner ring responsive to pressure acting on the reverse flow side of the valve seat assembly.

FIG. 12 illustrates the force on the outer ring responsive to pressure acting on the reverse flow side of the valve seat assembly.

FIG. 13 is a partial view of a rotary cylindrical plug valve having a self-adjusting valve seat assembly.

FIG. 14 is a partial view of a ball valve having a self-adjusting valve seat assembly.

### DETAILED DESCRIPTION OF THE INVENTION

The use of balls and plugs as sealing elements in rotary valves is well known. A wedge-shaped sealing element in a rotary valve is less well known; its use in a valve body is described in U.S. Pat. Nos. 4,962,911 and 5,333,834, which are hereby incorporated by reference.

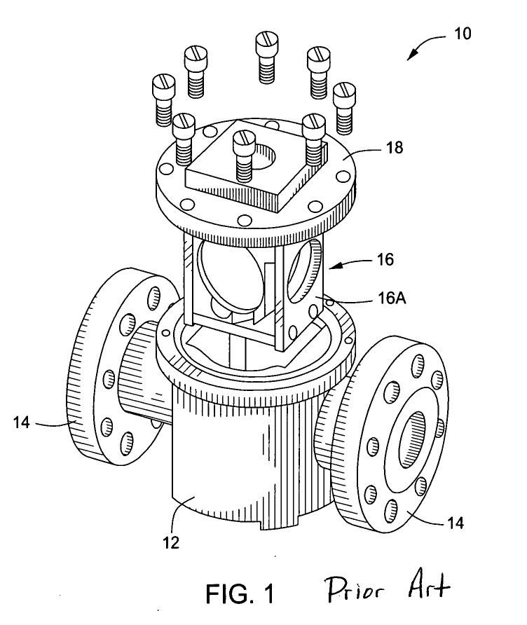

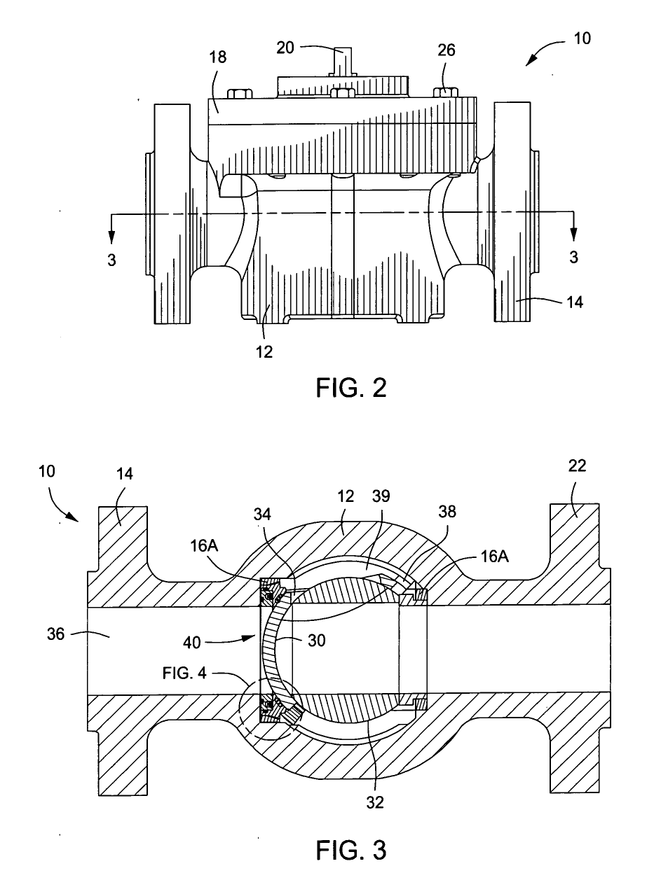

U.S. Pat. App. Pub. No. US 2006/0196544, which is hereby incorporated by reference, discloses a wedge-shaped sealing element, such as disclosed in U.S. Pat. Nos. 4,962,911 and 5,333,834, in a rotary cartridge valve. A cartridge valve is illustrated in FIG. 1. Valve 10 has body 12 and connection flanges 14. Cartridge 16, having plates 16A, may be removed from body 12 by removal of bonnet 18 for replacement of valve elements within the cartridge without disconnecting the flanges of the valve. Valve 10 may be operated by turning a stem (not shown) by about 90 degrees. FIG. 2 illustrates cartridge valve 10 with bonnet 18 and stem 20 in place. The cartridge is adapted to fit in valve body 12 and be easily removable for replacement of all valve elements contained within the cartridge.

Cartridge 16 (FIG. 1) contains a sealing element, which may be any rotary element, such as a ball or plug, but preferably is a wedge-shaped sealing element such as described in Pub. No. US 2006/0196544. Cartridge 16 includes plates 16A having an opening for flow therethrough that may provide for pass-through of a sealing surface for contacting the wall of the cavity in body 12 to form a pressure seal.

FIG. 3 is a plan view of one embodiment of cartridge valve 10 having a wedge-shaped sealing element and a self-adjusting valve seat as disclosed herein. Sealing element 30, shown in the closed position, is adapted to rotate in a horizontal plane around core 32. The valve is opened by rotating element 30 such that port 34 in element 30 is moved into flow channel 36. Driver 38 applies the force necessary to rotate element 30 for opening and closing the valve within cavity 39 of body 12. Sealing to prevent flow through the valve when closed is provided by self-adjusting valve seat 40, which seals on one side against the surface of cavity 39 and on the opposite side against rotating valve element 30. Although it cannot be seen at the scale of the drawing, rotating element 30 is preferably of varying thickness such that the thickness is greater in that portion of the element that is in contact with seals when the valve is rotated into the closed position. This greater thickness causes a compressive force on the seals in the valve.

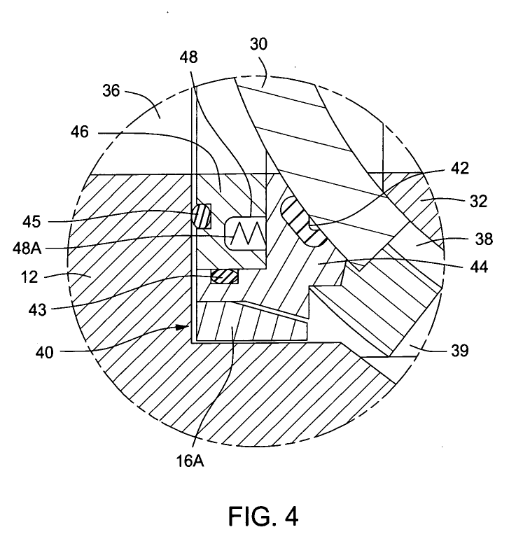

FIG. 4 is a detailed view of the portion of the self-adjusting valve seat that is encircled in FIG. 3. Rotating element 30 is shown in the closed position, preferably pressed against core 32. It may be moved to the open position by driver 38. Inner ring 46 of self-adjusting valve seat 40 (FIG. 3) is adapted to be placed in a slidable relationship within outer ring 44. Outer ring 44 of self-adjusting valve seat 40 (FIG. 3) contains main seal 42. Preferably, outer ring 44 includes a diameter larger than the opening in cartridge plate 16A, as shown in FIG. 4. Valve seat 40 may then be assembled by insertion in plate 16A from within cartridge 16.

A spring groove, such as groove 48 in inner ring 46, is preferably provided in inner ring 46 or outer ring 44. Spring groove 48 may contain spring 48A, which may include a plurality of coil springs or other forms of spring. Preferably spring 48A is a wave spring. Material used in spring 48A may be an elastomer or a metal. Spring 48A provides force to actuate main seal 42 and body seal 45 when mechanical tolerances in a valve allow a gap or low sealing pressure to be present in the valve. This actuation prevents leaks in a valve when pressure is applied in the reverse flow direction (from the left in FIG. 4). Seal 43, between inner ring 46 and outer ring 44, and seal 45, on the outer surface of inner ring 46, allow activation of seal 42 on the rotating element and seal 45 on the wall of cavity 39 in body 12 when pressure is present in the reverse flow direction of the valve, as will be explained below.

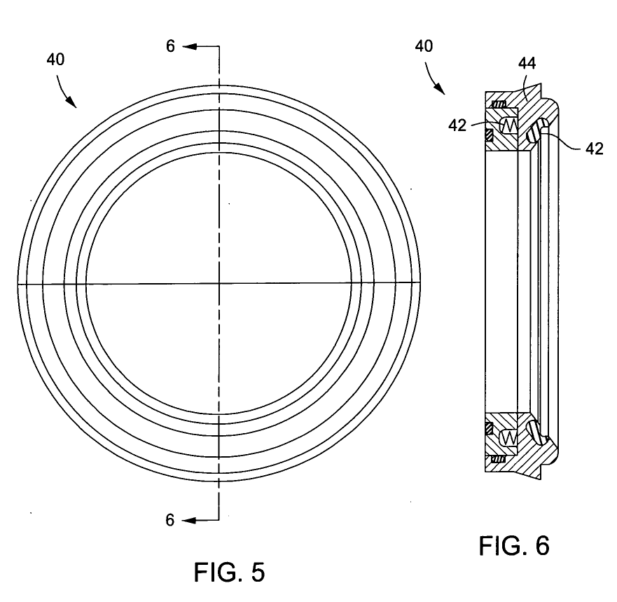

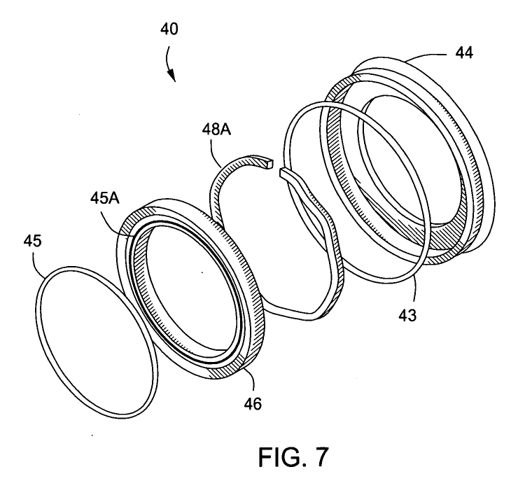

FIGS. 5, 6 and 7 are various views of self-adjusting valve seat 40 showing components identified above. FIG. 5 is an elevation view of the self-adjusting valve seat 40 of FIG. 3 from the direction of the rotating element of FIG. 3 or FIG. 4. FIG. 6 is a cross-section of self-adjusting valve seat 40. FIG. 7 is an exploded isometric illustration showing the various components of the self-adjusting valve seat as identified above.

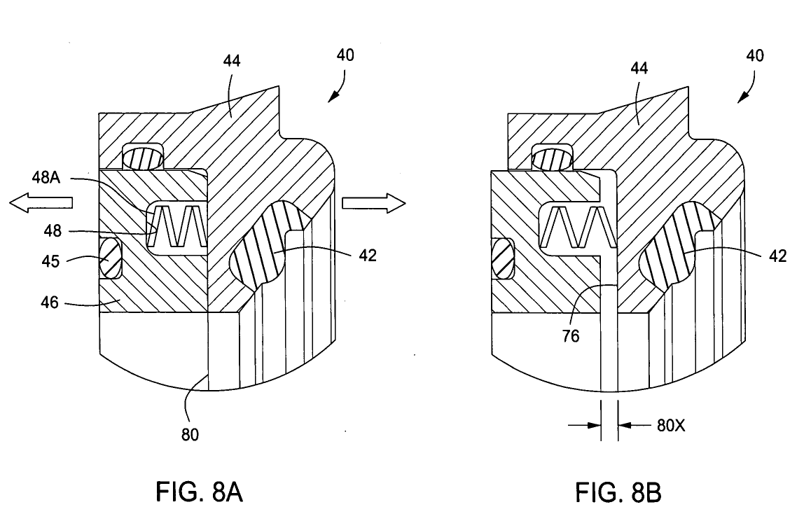

FIGS. 8A and 8B illustrate expansion gap 80 (FIG. 8A), which may form when thermal effects during usage or mechanical tolerances during manufacture of a valve cause the force on sealing elements 42 and 45 to decrease to zero. In FIG. 8A, the gap is closed and pressure can be applied to seals 42 and 45. In FIG. 8B, changes in dimensions or mechanical tolerances of parts have allowed formation of gap 80X, which may be called an “extrusion gap.” To avoid sealing pressure dropping to zero, spring 48A may be inserted in groove 48. Spring 48A has a stiffness selected to apply pressure above a selected sealing pressure at its maximum extension. Spring 48A may be a metallic wave spring, a rubber body, a compressed gas, or any other form of spring having desired stiffness characteristics. The maximum extension expected will depend on maximum mechanical tolerances expected during manufacture of the valve and expected thermal changes affecting extrusion gap 80X.

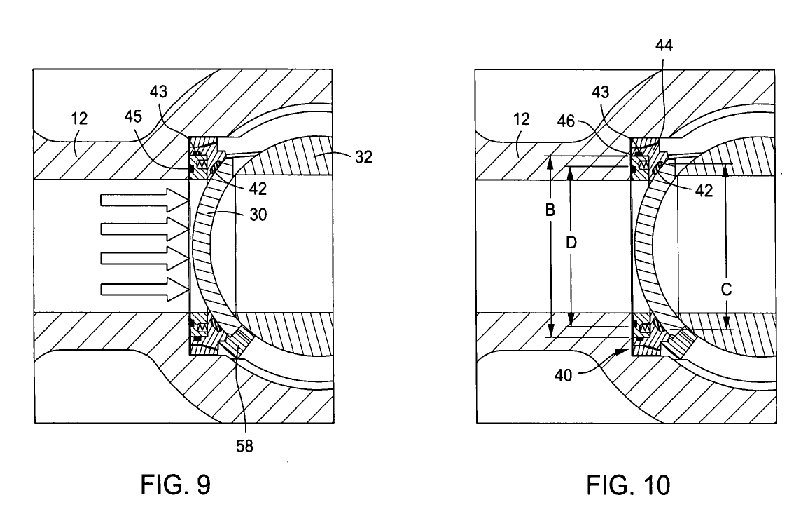

For low pressures or high pressures in a rotary valve such as disclosed herein, if flow is in the preferred or forward direction fluid pressure against the sealing element (ball, plug, or wedge-shaped element) will normally apply pressure to the valve seat and prevent leakage. If flow is in the non-preferred or reverse direction, however, the force on sealing element 42 necessary to prevent leakage of the valve must produce a sealing pressure in element 42 greater than the pressure in the fluid to be controlled. At high differential pressures in the reverse direction across valve element 40 of FIG. 3 or 4, the force that must be exerted by spring 48A to avoid leakage of the valve becomes excessive. For higher differential pressures, the valve seat assembly disclosed herein provides a self-actuating hydraulic mechanism. Referring to FIG. 9, the arrows indicate the force on rotary sealing element 30 from differential pressure in the non-preferred or reverse direction. When pressure in the fluid becomes greater than the sealing pressure exerted on sealing elements 42 and 45, the valve will leak. The pressure on sealing elements 42 and 45 exerted by spring 48A will not be sufficient to prevent leaks at higher differential pressures. Another mechanism to apply force to the seals and avoid leakage of fluid when pressure is in the non-preferred direction is required. FIG. 10 illustrates how this additional force may be provided by the two-piece self-adjusting valve seat disclosed herein. Hydraulic pressure acting on the two parts of the self-actuating valve seat 40 may be used to apply a sealing force proportional to fluid pressure in the non-preferred direction. This force may be explained by referring to FIGS. 10, 11 and 12.

In FIGS. 10, B, C and D represent diameters of areas exposed to pressure in the non-preferred direction. B is the diameter of seal 43 between the rings. D is the diameter of the body seal or second seal and C is the diameter of the main seal. The force exerted on each part of the self-adjusting seat is equal to area exposed to pressure times pressure in the reverse or non-preferred direction (Pₙₚ), so the forces on the seal parts are:

F_{seal 1}=Pₙₚ×π/4(B²−C²) (on outer ring 44), and

F_{seal 2}=Pₙₚ×π/4(B²−D²) (on inner ring 46).

For example, if Pₙₚ is 1000 psi, B=2.1 inches and C=2 inches, the force applied to the outer ring 44 (F_{seal 1}) is 322 pounds (assuming negligible pressure in the preferred direction). This force will be sufficient to prevent leakage past seal element 42. The basic requirement is that B>C.

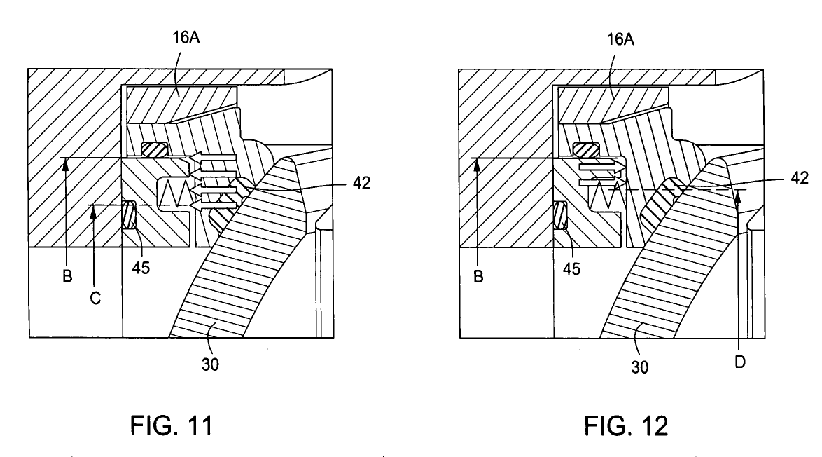

If D=2 inches, the same force will be applied in the opposite direction to the inner ring 46. This force (F_{seal 2}) will be sufficient to prevent leakage past seal element 45. The basic requirement to provide a sealing force on the base part is that B>D. FIGS. 11 and 12 illustrate with arrows the areas where pressure will create the forces in opposite directions to cause sealing of seal elements 42 and 45.

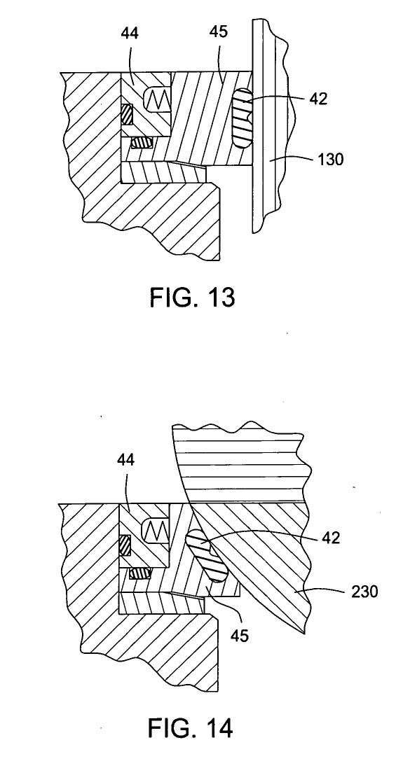

FIGS. 13 and 14 illustrate application of the principles of the valve seat assembly disclosed herein to other rotatable sealing elements. In FIG. 13, application to a plug valve is illustrated, where plug 130 is shown, and in FIG. 14 application to a ball valve is illustrated, where ball 230 is shown.

To demonstrate the efficacy of the self-actuating valve seat disclosed herein, tests were performed using a cartridge valve having a wedge-shaped sealing element. The valve under normal conditions and without the valve assembly disclosed herein leaked when pressure was applied in the reverse-flow direction unless spacers were used to provide an almost exact fit of the rotating element between seals. Then the assembly disclosed herein was inserted and successively smaller spacers were inserted in increments of 0.005 inch, causing larger extrusion gaps. It was found that spacer thickness could be decreased up to 0.025 inch without the valve leaking with pressure in the reverse-flow direction. Pressure was applied and the valve was opened and closed through multiple cycles. Maximum pressure applied was above the normal pressure range for the valve. The spring-loaded actuation prevented leakage at low differential pressures and the hydraulic mechanism prevented leakage at high differential pressures.

Although the present invention has been described with reference to specific details, it is not intended that such details should be regarded as limitations on the scope of the invention, except as and to the extent that they are included in the accompanying claims.

What I claim is:

1. A valve seat assembly, comprising:
an outer ring having a main seal, the main seal having a diameter and being adapted for sealing against a rotatable sealing element;
an inner ring having a body seal, the body seal having a diameter and being adapted for sealing against a valve body when the valve seat assembly is disposed between the rotatable sealing element and the valve body and being adapted for sliding within the outer ring;
a spring for applying force to cause sliding between the outer ring and the inner ring and to force apart the main seal and the body seal; and
a sliding seal between the outer ring and the inner ring, the sliding seal having a diameter, the diameter of the sliding seal being greater than the diameter of the main seal and the diameter of the body seal.

2. The valve seat assembly of claim 1 wherein the rotatable sealing element is wedge-shaped.

3. The valve seat assembly of claim 1 wherein the sliding seal comprises an o-ring in a groove in the outer ring.

4. The valve seat assembly of claim 1 wherein the spring is a wave spring.

5. The valve seat assembly of claim 1 wherein the spring is disposed in a groove in the inner ring.

6. A valve, comprising:
the valve seat assembly of claim 1;
a valve body, the valve body having a cavity, the cavity having a wall, the wall being disposed so as to contact the body seal of the valve seat assembly;
a valve bonnet and a valve stem; and
a rotatable sealing element.

7. The valve of claim 6 further comprising a cartridge, the cartridge comprising plates having openings for flow therethrough.

8. The valve of claim 7 wherein the openings have a diameter less than an outside diameter of the outer ring.

9. A method for sealing a valve having a valve body and having a rotatable sealing element, comprising:
providing an outer ring having a main seal adapted for sealing against the rotatable sealing element;
providing an inner ring having a body seal adapted for sealing against the valve body, the inner ring being adapted for sliding concentrically within the outer ring;
providing a spring for applying force to cause sliding between the outer ring and the inner ring;
providing a seal between the outer ring and the inner ring;
assembling the inner ring and the outer ring, with the seal and the spring therebetween; and
placing the assembly in the valve body between the rotatable sealing element and a wall of the valve body.

10. The method of claim 9 further comprising placing a cartridge in the valve body, the cartridge containing the outer ring, the inner ring, the spring, the seal between the outer ring and the inner ring and the rotatable seal element.
